(19) United States
(12) Patent Application Publication
(10) Pub. No.: US 2011/0175264 A1
(43) Pub. Date: Jul. 21, 2011

(54) High Toughness Ceramic Composites

(76) Inventors: Vimal K. Pujari, Northborough, MA (US); Eric Jorge, Les Valayans (FR); Christopher J. Reilly, Whitinsville, MA (US)

(21) Appl. No.: 12/841,432

(22) Filed: Jul. 22, 2010

Related U.S. Application Data
(60) Provisional application No. 61/271,738, filed on Jul. 24, 2009.

(51) Int. Cl. C04B 35/565; C04B 35/563; C04B 35/532; B82Y 30/00

(52) U.S. Cl. 264/625; 264/682; 501/91; 501/90; 977/773

(57) ABSTRACT

A method of forming a sintered silicon carbide body includes mixing silicon carbide powder having an oxygen content of less than about 3 wt % and having a surface area in a range of between about 8 m²/g and about 15 m²/g, with boron carbide powder and carbon sintering aid to form a green silicon carbide body. Alternatively, a method of producing a sintered silicon carbide body includes mixing the silicon carbide powder with titanium carbide powder having an average particle diameter in a range of between about 5 nm and about 100 nm and with carbon sintering aid to form a green silicon carbide body. In another alternative, a method of forming a sintered silicon carbide body includes mixing silicon carbide powder with boron carbide powder, the titanium carbide powder, and carbon sintering aid to form a green silicon carbide body. After sintering, the silicon carbide bodies have a density at least 98% of the theoretical density of silicon carbide.

### RELATED APPLICATION

This application claims the benefit of U.S. Provisional Application No. 61/271,738, filed on Jul. 24, 2009.

The entire teachings of the above application are incorporated herein by reference.

### BACKGROUND OF THE INVENTION

Ceramic materials are well suited for armor plate applications, due to their lower weight compared to metals. The excellent mechanical, thermal, and ballistic properties of silicon carbide make it a good choice for armor plate components. Due to its relatively low fracture toughness, however, silicon carbide is susceptible to chipping damage and failure in multi-shot capability, an important requirement in armor plate applications. Therefore, there is a need for further improvements in ceramic materials for armor plate applications.

### SUMMARY OF THE INVENTION

This invention is generally directed to green silicon carbide bodies and methods of forming high toughness ceramic composites from the green silicon carbide bodies. In one embodiment, a green silicon carbide body includes silicon carbide powder having an oxygen content of less than about 3 wt % and having a surface area in a range of between about 8 m²/g and about 15 m²/g, boron carbide powder, and carbon sintering aid. In another embodiment, a green silicon carbide body includes silicon carbide powder having an oxygen content of less than about 3 wt % and having a surface area in a range of between about 8 m²/g and about 15 m²/g, titanium carbide powder having an average particle diameter in a range of between about 5 nm and about 100 nm, and carbon sintering aid. In yet another embodiment, a green silicon carbide body includes silicon carbide powder having an oxygen content of less than about 3 wt % and having a surface area in a range of between about 8 m²/g and about 15 m²/g, boron carbide powder, titanium carbide powder having an average particle diameter in a range of between about 5 nm and about 100 nm, and carbon sintering aid.

In another embodiment, a method of forming a sintered silicon carbide body includes mixing silicon carbide powder having an oxygen content of less than about 3 wt % and having a surface area in a range of between about 8 m²/g and about 15 m²/g, with boron carbide powder and carbon sintering aid to form a green mixture. The method further includes shaping the green mixture into a green silicon carbide body and sintering the green silicon carbide body in an atmosphere in which it is substantially inert at a temperature in a range of between about 2125° C. and about 2250° C. for a time period in a range of between about two hours and about four hours to thereby form a sintered silicon carbide body having a density of at least 98% of the theoretical density of silicon carbide. In certain embodiments, boron carbide can be present in the green mixture in an amount in a range of between about 10 wt % and about 40 wt %. The boron carbide powder can have a surface area in a range of between about 6 m²/g and about 18 m²/g. In certain embodiments, carbon sintering aid can be present in the green mixture, at least in part, as carbon black. In other embodiments, carbon sintering aid can be present in the green mixture, at least in part, as phenolic resin. In some embodiments, carbon sintering aid can be present in the green mixture in an amount in a range of between about 2 wt % and about 8 wt %.

In still another embodiment, a method of producing a sintered silicon carbide body includes mixing silicon carbide powder having an oxygen content of less than about 3 wt % and having a surface area in a range of between about 8 m²/g and about 15 m²/g, with titanium carbide powder having an average particle diameter in a range of between about 5 nm and about 100 nm and carbon sintering aid to form a green mixture. The method further includes shaping the green mixture into a green silicon carbide body and sintering the green silicon carbide body in an atmosphere in which it is substantially inert at a temperature in a range of between about 2125° C. and about 2250° C. for a time period in a range of between about two hours and about four hours to thereby form a sintered body having a density of at least 98% of the theoretical density of silicon carbide. The average particle diameter of the titanium carbide powder can be in a range of between about 17 nm and about 25 nm. In some embodiments, titanium carbide can be present in the green mixture in a range of between about 1 wt % and about 3 wt %. In some embodiments, carbon sintering aid can be present in the green mixture, at least in part, as carbon black. In other embodiments, carbon sintering aid can be present in the green mixture, at least in part, as phenolic resin. The carbon can be present in the green mixture in an amount in a range of between about 2 wt % and about 8 wt %.

In yet another embodiment, a method of forming a sintered silicon carbide body includes mixing silicon carbide powder having an oxygen content of less than about 3 wt % and having a surface area in a range of between about 8 m²/g and about 15 m²/g with boron carbide powder and titanium carbide powder having an average particle diameter in a range of between about 5 nm and about 100 nm and carbon sintering aid to form a green mixture. The method further includes shaping the green mixture into a green silicon carbide body and sintering the green silicon carbide body in an atmosphere in which it is substantially inert at a temperature in a range of between about 2125° C. and about 2250° C. for a time period in a range of between about two hours and about four hours, to thereby form a sintered silicon carbide body having a density at least 98% of the theoretical density of silicon carbide.

This invention has many advantages, such as improved fracture toughness and improved hardness of ceramic components, enabling the production of lighter armor plate components for military and police protection.

### BRIEF DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1 is a photograph of a sintered silicon carbide body with about 20 wt % B₄C, that had a density of 3.01 g/cc (98.4% TD), a hardness of 20.9 GPa, and a fracture toughness of 2.64 MPa-m^{1/2}.

FIG. 2 is a photograph of a sintered silicon carbide body with about 1 wt % nano-TiC, that had a density of 3.18 g/cc (98.4% TD), a hardness of 24.86 GPa, a fracture toughness of 3.63-4.2 MPa-m^{1/2}% and a maximum grain length of 44 μm.

FIG. 3 is a photograph of a sintered silicon carbide body with about 1 wt % nano-TiC and about 20 wt % B₄C, that had a density of 3.04 g/cc (99.21% TD), a hardness of 27.52 GPa, a fracture toughness of 3.71 MPa-m^{1/2}, and a maximum grain length of 25.6 μm.

### DETAILED DESCRIPTION OF THE INVENTION

A description of example embodiments of the invention follows.

In one embodiment, a green silicon carbide body includes silicon carbide powder having an oxygen content of less than about 3 wt % and having a surface area in a range of between about 8 m²/g and about 15 m²/g, boron carbide powder, and carbon sintering aid. In another embodiment, a green silicon carbide body includes silicon carbide powder having an oxygen content of less than about 3 wt % and having a surface area in a range of between about 8 m²/g and about 15 m²/g, titanium carbide powder having an average particle diameter in a range of between about 5 nm and about 100 nm, and carbon sintering aid. In yet another embodiment, a green silicon carbide body includes silicon carbide powder having an oxygen content of less than about 3 wt % and having a surface area in a range of between about 8 m²/g and about 15 m²/g, boron carbide powder, titanium carbide powder having an average particle diameter in a range of between about 5 nm and about 100 nm, and carbon sintering aid. In still another embodiment, a green silicon carbide body includes silicon carbide powder having an oxygen content of less than about 3 wt % and having a surface area in a range of between about 8 m²/g and about 15 m²/g, boron carbide powder, carbon nanotube powder, and carbon sintering aid. Boron carbide is present in an amount in a range of between about 10 wt % and about 40 wt %, preferably about 20 wt %. Boron carbide powder has a surface area in a range of between about 6 m²/g and about 18 m²/g. Titanium carbide powder has an average particle diameter in a range of between about 5 nm and about 100 nm, preferably in a range of between about 17 nm and about 25 nm. Titanium carbide is present in an amount in a range of between about 1 wt % and about 3 wt %, preferably in an amount of about 1 wt %. Carbon nanotube powder can be present in an amount in a range of between about 1 wt % and about 5 wt %, preferably between about 1 wt % and about 3 wt %. Carbon sintering aid can be present at least in part as phenolic resin. Alternatively, carbon sintering aid can be present at least in part as carbon black. Carbon sintering aid is present in an amount in a range of between about 2 wt % and about 8 wt %, preferably about 3 wt %.

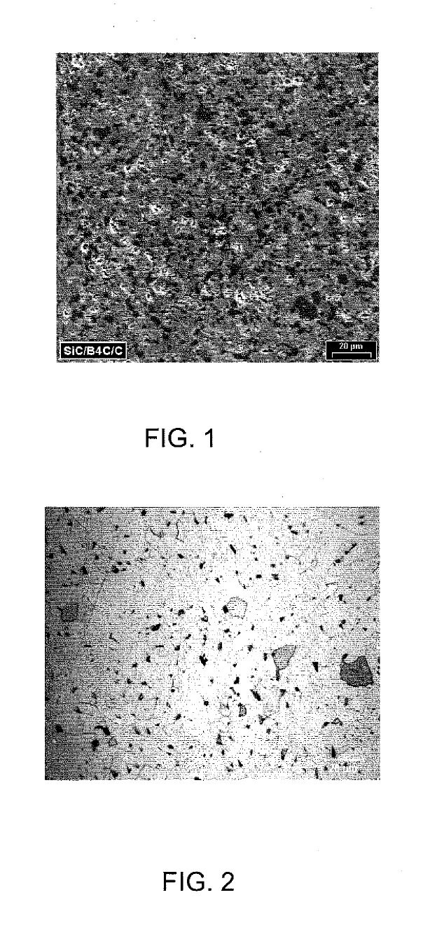

In another embodiment, a method of forming a sintered silicon carbide body includes mixing silicon carbide powder having an oxygen content of about 1.5 wt % and having a surface area of about 10 m²/g and an average particle size (D₅₀) of about 0.8 μm, with boron carbide powder and carbon to form a green mixture. An aqueous suspension of about 50 wt % solids of B₄C at a pH greater than about 8 is added to a silicon carbide suspension of about 50 wt % solids at a pH of about 9.5, and thoroughly mixed at high shear. Next, about 2-8 wt % carbon sintering aid, preferably about 3 wt %, in the form of phenolic resin or carbon black, is added to the combined SiC/B₄C suspension under high shear. The slurry is then spray dried or freeze dried. The method further includes shaping the green mixture into a green silicon carbide body, by die pressing or cold isostatically pressing (CIP) at a pressure in a range of about 15,000 lb/in² (15 KSI) to about 30 KSI. The green silicon carbide body is then sintered in an atmosphere in which it is substantially inert, preferably an Argon atmosphere, at a temperature in a range of between about 2125° C. and about 2250° C., preferably about 2150° C., for a time period in a range of between about two hours and about four hours, preferably about 3 hours, in a graphite or SiC crucible, to thereby form a sintered silicon carbide body having a density of at least 98% of the theoretical density of silicon carbide. In certain embodiments, boron carbide can be present in the green mixture in an amount in a range of between about 10 wt % and about 40 wt %, preferably about 20 wt %. The boron carbide powder can have a surface area in a range of between about 6 m²/g and about 18 m²/g, preferably about 15 m²/g with a particle size (D₅₀) of about 0.5 μm. An example is shown in FIG. 1.

In still another embodiment, a method of producing a sintered silicon carbide body includes mixing silicon carbide powder having an oxygen content of about 1.5 wt % and having a surface area of about 10 m²/g and an average particle size (D₅₀) of about 0.8 μm, with titanium carbide powder having an average particle diameter in a range of between about 5 nm and about 100 nm, preferably in a range of between about 17 nm and about 25 nm, and carbon sintering aid to form a green mixture. Suitable titanium carbide powder (nano-TiC) can be obtained, for example, from SDC Materials, Inc. (Tempe, Ariz.). See application Ser. No. 12/152,096 of Biberger et al., published as U.S. 2008/0277270 on Nov. 13, 2008. A well mixed aqueous suspension of 1-3 wt % nano-TiC, preferably about 1 wt %, at pH 7.4 is added to a well dispersed aqueous suspension of SiC, containing about 50 wt % solids, at pH 9.5. The silicon carbide powder typically has the same specifications as described above. After addition, the composite slurry is sonicated for about 30 minutes. Next, about 2-8 wt % carbon sintering aid, preferably about 3 wt %, is added in the form of phenolic resin or carbon black, preferably phenolic resin, and the mixture is well mixed using a high shear mixer. The mixture is then either spray dried or freeze dried as described above to form a green mixture.

The method further includes shaping the green mixture into a green silicon carbide body, using the methods described above, and sintering the green silicon carbide body in a graphite or silicon carbide crucible in an atmosphere in which it is substantially inert, preferably an Argon atmosphere, at a temperature in a range of between about 2125° C. and about 2250° C., preferably at a temperature in a range of between about 2150° C. and about 2200° C., more preferably at a temperature of about 2150° C., for a time period in a range of between about one hour and about four hours, preferably about one hour, to thereby form a sintered silicon carbide body having a density of at least 98% of the theoretical density of silicon carbide. An example is shown in FIG. 2.

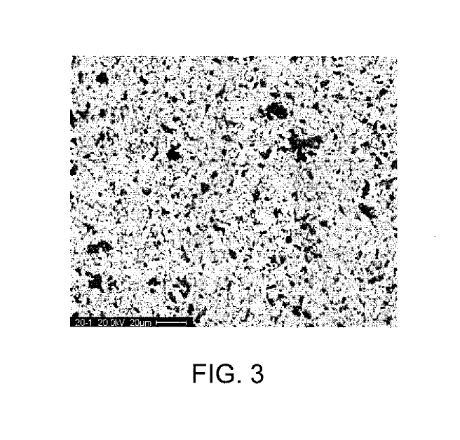

In yet another embodiment, a method of forming a sintered silicon carbide body includes mixing silicon carbide powder having an oxygen content of about 1.5 wt % and having a surface area of about 10 m²/g and an average particle size (D₅₀) of about 0.8 μm with boron carbide powder, titanium carbide powder, and carbon sintering aid to form a green mixture. The specifications for the silicon carbide powder, the boron carbide powder, and the nano-TiC powder are the same as described above for the respective powder. To make this three component mixture, first, the nano-TiC slurry is dispersed in the SiC suspension as described above. Then, an aqueous dispersion of B₄C at pH greater than about 8 is added to the slurry to achieve about 10-40 wt % B₄C, preferably about 20 wt %. After the same shaping procedure described above, the green silicon carbide body is sintered in a graphite crucible in an atmosphere in which it is substantially inert, preferably an Argon atmosphere, at a temperature in a range of between about 2125° C. and about 2250° C., preferably about 2150° C., for a time period in a range of between about one hour and about four hours, preferably about three hours, to thereby form a sintered silicon carbide body having a density of at least 98% of the theoretical density of silicon carbide. An example is shown in FIG. 3.

In still another embodiment, a method of forming a sintered silicon carbide body includes mixing silicon carbide powder having an oxygen content of about 1.5 wt % and having a surface area of about 10 m²/g and an average particle size (D₅₀) of about 0.8 μm with boron carbide powder, carbon nanotube powder, and carbon sintering aid to form a green mixture. The specifications for the silicon carbide powder and the boron carbide powder are the same as described above for the respective powder. The specifications for the carbon nanotube powder are the same as the specifications for the nano-TiC powder described above. To make this three component mixture, first, the carbon nanotube slurry is dispersed in the SiC suspension as described above for the nano-TiC slurry. Then, an aqueous dispersion of B₄C at pH greater than about 8 is added to the slurry to achieve about 10-40 wt % B₄C, preferably about 20 wt %. After the same shaping procedure described above, the green silicon carbide body is sintered in a graphite crucible in an atmosphere in which it is substantially inert, preferably an Argon atmosphere, at a temperature in a range of between about 2125° C. and about 2250° C., preferably about 2150° C., for a time period in a range of between about one hour and about four hours, preferably about three hours, to thereby form a sintered silicon carbide body having a density of at least 98% of the theoretical density of silicon carbide.

### Exemplification

An aqueous suspension of 1.5 wt % oxygen content SiC was prepared at a pH of 9.5. The slurry was sonicated for 30 minutes and then well dispersed (pH˜7.5) suspension of 17-25 nm TiC was added to this slurry. After high shear mixing, a low oxygen boron carbide powder was added to this suspension and further mixed using high shear. The low oxygen boron carbide powder was prepared according to the procedure in application Ser. No. 12/221,916, filed on Aug. 7, 2008. Finally, 10 wt % phenolic resin was added to this suspension to result in 4 wt % carbon sintering aid after pyrolysis. The suspension so prepared contains approximately 55 wt % of solids (powder), where the SiC, B₄C and nano-TiC ratios are 79 wt %, 20 wt % and 1 wt % respectively. This slurry was spray dried to achieve ˜80-100 μm size granules. The spray dried powder was pressed at 18 KSI to form a green compact.

This green compact (green silicon carbide body), pressed to 62% TD, made from a low oxygen content (<1.5 wt %), 8 m²/g surface area SiC powder containing 4 wt % carbon sintering aid (as phenolic resin), fine (−1 μm) 20 wt % boron carbide and 1 wt % nano-TiC (17-25 nm) was sintered in Argon gas environment at about 2180° C. for about 3 hours. After sintering the compact reached a density of >99% TD. The sintered microstructure showed well dispersed B₄C and nano-TiC particles in the SiC matrix, as shown in FIGS. 1 and 3.

SiC matrix containing either 20% B₄C or 1 w % nTiC separately has shown 20% and 60% improvements respectively in the measured fracture toughness over the base line silicon carbide. However in the case of SiC/B₄C composite system, up to 15% loss in hardness is noticed. Nano-TiC addition to SIC results in improved fracture toughness without loss in hardness, but at the cost of increased overall weight which is a critical property for armor application. By combining both the second phase particulates (B₄C and nano-TiC) in the SiC matrix, improvements in sintered density, fracture toughness, and hardness can be realized without any weight penalty. In fact, this novel composite system offers up to 7% reduction in weight which is an important factor for body armor systems.

A summary of the properties of sintered composites prepared according to the methods described above is shown in Table 1, and compared to standard Hexoloy (SA) and hot pressed material.

TABLE 1
Lower weight toughened SiC composites for multi-shot capability

| | | | | Fracture | |
|---|---|---|---|---|---|
| | | | | Toughness - | |
| | | | Hardness | KIC | |
| | Density | | (GPa) | (MPa-m^{1/2}) | MOR |
| Material | g/cc (% TD) | | 1 Kg. | 1 Kg.(Niihara) | (MPa) |
| Hexoloy (SA) | 3.16 | (98.4) | 25 | 3.41 | 380 |
| SiC-N | 3.2 | (99.9) | 24 | 4.5 | 600 |
| CERCOM | | | | | |
| (Hot Pressed) | | | | | |
| SB | 3.01 | (98.4) | 20.87 | 2.64 | — |
| (SA + 20%B4C) | | | | | |
| SA/1%nTiC | 3.18 | (99.21) | 24.86 | 4.20 | 383 |
| X185 freeze fried | | | | | |
| X191 spray dried | | | | | |
| SA/1%nTiC/ | 3.04 | (99.21) | 27.53 | 3.72 | |
| 20%B₄C | | | | | |
| Super Composite | | | | | |

The teachings of all patents, published applications and references cited herein are incorporated by reference in their entirety.

### Equivalents

While this invention has been particularly shown and described with references to example embodiments thereof, it will be understood by those skilled in the art that various changes in form and details may be made therein without departing from the scope of the invention encompassed by the appended claims.

What is claimed is:

1. A green silicon carbide body comprising:
silicon carbide powder having an oxygen content of less than about 3 wt % and having a surface area in a range of between about 8 m²/g and about 15 m²/g;
boron carbide powder; and
carbon sintering aid.

2. The green silicon carbide body of claim 1, wherein boron carbide is present in an amount in a range of between about 10 wt % and about 40 wt %.

3. The green silicon carbide body of claim 1, wherein the boron carbide powder has a surface area in a range of between about 6 m²/g and about 18 m²/g.

4. The green silicon carbide body of claim 1, wherein carbon sintering aid is present at least in part as one of phenolic resin and carbon black.

5. The green silicon carbide body of claim 1, wherein carbon sintering aid is present in an amount in a range of between about 2 wt % and about 8 wt %.

6. A green silicon carbide body comprising:
silicon carbide powder having an oxygen content of less than about 3 wt % and having a surface area in a range of between about 8 m²/g and about 15 m²/g;
titanium carbide powder having an average particle diameter in a range of between about 5 nm and about 100 nm; and
carbon sintering aid.

7. A green silicon carbide body comprising:
silicon carbide powder having an oxygen content of less than about 3 wt % and having a surface area in a range of between about 8 m²/g and about 15 m²/g;
boron carbide powder;
titanium carbide powder having an average particle diameter in a range of between about 5 nm and about 100 nm; and
carbon sintering aid.

8. The green silicon carbide body of claim 7, wherein boron carbide is present in an amount in a range of between about 10 wt % and about 40 wt %.

9. The green silicon carbide body of claim 7, wherein the boron carbide powder has a surface area in a range of between about 6 m²/g and about 18 m²/g.

10. The green silicon carbide body of claim 7, wherein titanium carbide is present in an amount in a range of between about 1 wt % and about 3 wt %.

11. The green silicon carbide body of claim 7, wherein carbon sintering aid is present at least in part as one of phenolic resin and carbon black.

12. The green silicon carbide body of claim 7, wherein carbon sintering aid is present in an amount in a range of between about 2 wt % and about 8 wt %.

13. A method of forming a sintered silicon carbide body comprising:
mixing silicon carbide powder having an oxygen content of less than about 3 wt % and having a surface area in a range of between about 8 m²/g and about 15 m²/g, with boron carbide powder and carbon sintering aid to form a green mixture;
shaping the green mixture into a green silicon carbide body; and
sintering the green silicon carbide body in an atmosphere in which it is substantially inert at a temperature in a range of between about 2125° C. and about 2250° C. for a time period in a range of between about two hours and about four hours, to thereby form a sintered silicon carbide body having a density at least 98% of the theoretical density of silicon carbide.

14. The method of claim 13, wherein boron carbide is present in the green mixture in an amount in a range of between about 10 wt % and about 40 wt %.

15. The method of claim 14, wherein the boron carbide powder has a surface area in a range of between about 6 m²/g and about 18 m²/g.

16. The method of claim 13, wherein carbon sintering aid is present in the green mixture at least in part as one of phenolic resin and carbon black.

17. The method of claim 13, wherein carbon sintering aid is present in the green mixture in an amount in a range of between about 2 wt % and about 8 wt %.

18. A method of producing a sintered silicon carbide body comprising:
mixing silicon carbide powder having an oxygen content of less than about 3 wt % and having a surface area in a range of between about 8 m²/g and about 15 m²/g, with titanium carbide powder having an average particle diameter in a range of between about 5 nm and about 100 nm and carbon sintering aid to form a green mixture;
shaping the green mixture into a green silicon carbide body; and
sintering the green silicon carbide body in an atmosphere in which it is substantially inert at a temperature in a range of between about 2125° C. and about 2250° C. for a time period in a range of between about two hours and about four hours, to thereby form a sintered silicon carbide body having a density at least 98% of the theoretical density of silicon carbide.

19. A method of forming a sintered silicon carbide body comprising:
mixing silicon carbide powder having an oxygen content of less than about 3 wt % and having a surface area in a range of between about 8 m²/g and about 15 m²/g, with boron carbide powder, titanium carbide powder having an average particle diameter in a range of between about 5 nm and about 100 nm, and carbon sintering aid to form a green mixture;
shaping the green mixture into a green silicon carbide body; and
sintering the green silicon carbide body in an atmosphere in which it is substantially inert at a temperature in a range of between about 2125° C. and about 2250° C. for a time period in a range of between about two hours and about four hours, to thereby form a sintered silicon carbide body having a density at least 98% of the theoretical density of silicon carbide.

20. The method of claim 19, wherein boron carbide is present in the green mixture in an amount in a range of between about 10 wt % and about 40 wt %.

21. The method of claim 20, wherein the boron carbide powder has a surface area in a range of between about 6 m²/g and about 18 m²/g.

22. The method of claim 19, wherein titanium carbide is present in the green mixture in an amount in a range of between about 1 wt % and about 3 wt %.

23. The method of claim 19, wherein carbon sintering aid is present in the green mixture at least in part as one of phenolic resin and carbon black.

24. The method of claim 19, wherein carbon sintering aid is present in the green mixture in an amount in a range of between about 2 wt % and about 8 wt %.
